(19) United States
(12) Patent Application Publication
(10) Pub. No.: US 2007/0041107 A1
(43) Pub. Date: Feb. 22, 2007

(54) Vehicle mirror with improved reflected object distance gauging indication and method

(76) Inventor: Richards P. Lyon, Napa, CA (US)

Correspondence Address: BEESON SKINNER BEVERLY, LLP, ONE KAISER PLAZA, SUITE 750, OAKLAND, CA, 94612, US

(21) Appl. No.: 11/506,601

(22) Filed: Aug. 18, 2006

Related U.S. Application Data
(60) Provisional application No. 60/709,594, filed on Aug. 19, 2005.

(51) Int. Cl. G02B 5/08

(52) U.S. Cl. 359/838

(57) ABSTRACT

A visually perceptible target area is provided on the reflective surface of a side view mirror of a vehicle which the eye can compare and easily correlate to the image of a trailing vehicle reflected in the mirror. The target area can be provided by a view frame, which can be adhered to, suspended in front of, or etched into the mirror's reflective surface. Alternatively, the target area can be a visually perceptible, reflective area on the mirror's reflective surface, such as a colored or tinted area. The target area is sized and shaped such that the reflected image of a vehicle of normal size will very approximately correspond in size and shape to the size and shape of the target area when the trailing vehicle is at a defined trailing distance behind the vehicle to which the mirror is attached. The target area is reflective, and is preferably bounded by substantially rectilinear sides to preferably provide for a box-shaped target area.

### CROSS-REFERENCE TO RELATED APPLICATIONS

This application claims the benefit of U.S. provisional application Ser. No. 60/709,594, filed Aug. 19, 2005.

### BACKGROUND

The present invention generally relates to vehicle side view mirrors that provide a driver with a field of view behind and to the sides of his or her vehicle, and more particularly relates to providing markings or visual targets on side view mirrors to assist the driver in gauging the distance of an object observed in the mirror.

Side view mirrors on automobiles and trucks allow drivers to see and monitor traffic behind the vehicle as well as to the side of the vehicle. Without the rear and side visibility provided by such mirrors, the ability to safely negotiate traffic and make safe lane changes would be greatly compromised. For this reason, side view mirrors, including driver and passenger side mirrors, are mandated on all vehicles.

A particular drawback of side view mirrors is the difficulty of gauging the distance at which a vehicle observed in the mirror trails the driver's vehicle. This problem is especially acute in passenger side view mirrors, which are typically convex to expand the field of view, but which distort the view such that vehicles or other objects observed in the mirror are shrunk in size and appear further away from the driver's vehicle than they actually are. Because of this distorting phenomenon, all passenger side view mirrors that are convex have the following message etched on the bottom edge of the mirror surface: “OBJECTS IN MIRROR ARE CLOSER THAN THEY APPEAR.” However, this warning is largely ineffective in a dynamic traffic situation, with the consequence that many accidents are caused by drivers misjudging the distance of a trailing vehicle observed in their passenger side mirror and making an unsafe lane change.

A number of solutions have been attempted to the distortion problem of convex mirrors. U.S. Pat. No. 5,644,442 to Peter Lemere discloses the use of two parallel vertical strips on a convex passenger side mirror for providing an indication of distance behind of a vehicle whose image is contained between the strips. U.S. Pat. No. 4,023,029 to Kenneth Fisher shows a convex mirror provided with a frosted non-reflective elongated horizontal line for providing a visual reference for safe lane changes. Another approach to providing distance indications on a convex mirror surface is disclosed in U.S. Pat. No. 1,311,253 to L. J. Stern. Here, graduated markings in the form of, alternatively, a series of horizontal lines and a series of concentric circles, are provided as a distance measuring technique. The difficulty with the foregoing approaches to providing distance indications on convex mirrors is that the markings do not provide a reliable and easily used reference for the driver to quickly spot a vehicle and gauge its distance: the markings do not easily correlate to the profile of the reflected vehicle image, and require too much visual interpretation. Markings which are simple lines are also often hard to see.

A need, therefore, exists for an improved marking scheme for a side view mirror of a vehicle, and particularly a convex mirror, that is easy to use and see, that provides a reasonably reliable indication of distance, and that can be confidently used to make safe lane changes. A need also exists for a marking system that can be easily applied to a convex side view mirror in accordance with the curvature of the mirror and in accordance with distances pre-determined to be safe for lane changes.

### SUMMARY OF THE INVENTION

The present invention overcomes the drawbacks of previous distance marking schemes for vehicle side view mirrors having convex reflective surfaces by providing a visually perceptible, and preferably box-shaped, target area on the mirror which the eye can easily compare and correlate to the image of a trailing vehicle reflected in the mirror. The target area is a bounded target area, and is sized and shaped such that the reflected image of the trailing vehicle will very approximately correspond to the size and shape of target area when the trailing vehicle is at a pre-established distance behind the driver's vehicle. This distance will be established in accordance with distances judged to be a minimum safe distance for a lane change, suitably about 45 feet behind the driver's vehicle. Preferably, the frame is dimensioned such that the reflected image profile of a normal sized vehicle would fit just within the target area when the reflected vehicle is at the pre-determined minimum safe distance for a lane change.

The target area on the side mirror's reflective surface is preferably substantially square. A substantially square view frame is believed to provide an optimal bounded box-shaped target area in reference to which the reflection of a trailing vehicle can be observed. As the distance between vehicles increases, the reflected image of the trailing vehicle will eventually shrink to substantially match the size of the box-shaped target area. By following the reflected image in the mirror and visually correlating the roughly box-shaped profile of the trailing vehicle image to the pre-sized box-shaped target area on or associated with the mirror, the driver will have a bounded rectilinear reference target that provides an easy-to-process visual indication of a safe vehicle distance for a safe lane change. The eye will be capable of immediately associating a reflected vehicle image on the mirror with the target area, even if the vehicle is not framed within the target area.

The box-shaped target area will suitably have a minimum dimension of approximately 1½″ and a maximum dimension of approximately 3″ on a side, depending on the design of the mirror and its use. It is contemplated that a target area having a dimension of between approximately 1½″ and 2¼″ on a side would be used on passenger side convex view mirrors, while a view frame having a larger target area dimension of approximately 3″ on a side would be used on a flat driver's side view mirror. In any event, the size of the target area is selected such that the image of a vehicle of a normal size will fit within the target area when the reflected vehicle is at a pre-established distance behind the driver's vehicle.

It is contemplated that the target area of the invention can be provided in any form that creates a visually perceptible area on the reflective surface of a side view mirror, such as providing a view frame of a thin plastic, metallic, or paper material having an adhesive backing that can be used to adhere the frame onto a side view mirror. Alternatively, it is contemplated that a view frame could be permanently etched onto the mirror. Other means of providing the box-shaped target area on the mirror are possible, such as suspending a view frame in front of the mirror's reflective surface, or providing a colored or tinted reflective area on the reflective surface of the mirror.

Another aspect of the invention involves a method for selecting target area sizes for use with a particular mirror. In accordance with this aspect of the invention, a sizing template is used to produce a measured viewing area on the mirror. Suitably, the template is provided in the form of a thin material that can be temporarily adhered to a mirror on which a view frame will be placed. The template can be provided with adhesive backing for adhering to the mirror surface, or could be adhered by means of adhesive tape or the like. An extended end of the horizontal leg of the template is provided with a series of markings correlated to different view frame sizes. To select a target area size, the sizing template is placed on a side view mirror of a vehicle, such as a convex passenger side view mirror, which is parked ahead of another stationary reference vehicle whose placement simulates a vehicle in an adjoining lane at a distance corresponding to a safe lane change distance. Seated in the driver's seat, the driver can adjust his or her side view mirror with the template to it to cause the reflection of the stationary vehicle behind to be reflected in the viewing area framed by the template. By aligning the reflected image of the vehicle behind to the inside edges of the vertical and horizontal legs of the template, the markings on the horizontal leg can be used to determine the size of the target area suitable for framing the vehicle's image at the established distance. A correspondingly-sized view frame or target area forming attachment is then selected and adhered to or otherwise provided on the side view mirror.

Thus, it can be seen that the present invention provides for improved means of marking side view mirrors, and particularly convex passenger side mirrors, with a distance marking scheme that will provide the driver with a confident indication of when a vehicle reflected in the mirror is at a safe distance behind a driver's vehicle for making safe lane changes. The invention improves the driver's ability to visually correlate a reflected image of a vehicle with the visual markings on the mirror, and avoids the high degree of uncertainty associated with prior art marking schemes.

### DESCRIPTION OF THE DRAWINGS

FIG. 1 is a graphical illustration of a side view mirror with a view frame in accordance with the invention.

FIG. 2 is an enlarged top perspective view of the view frame shown on the vehicle side view mirror in FIG. 1.

FIG. 3 is a graphical illustration of a side view mirror with a view frame sizing template in accordance with the invention adhered to the mirror.

FIG. 4 is a graphical illustration of a side view mirror with a view frame in accordance with the invention, showing an alternative mechanism for attaching the view frame to the mirror.

FIGS. 5A and 5B show alternative embodiments of the rectilinear view frame shown in FIG. 1, wherein the view frame is substantially closed.

FIG. 6 shows yet another version of the view frame of the invention wherein the view frame is a solid square, and is applied to the mirror on a clear adhesive backed sheet material.

### DESCRIPTION OF THE ILLUSTRATED EMBODIMENT

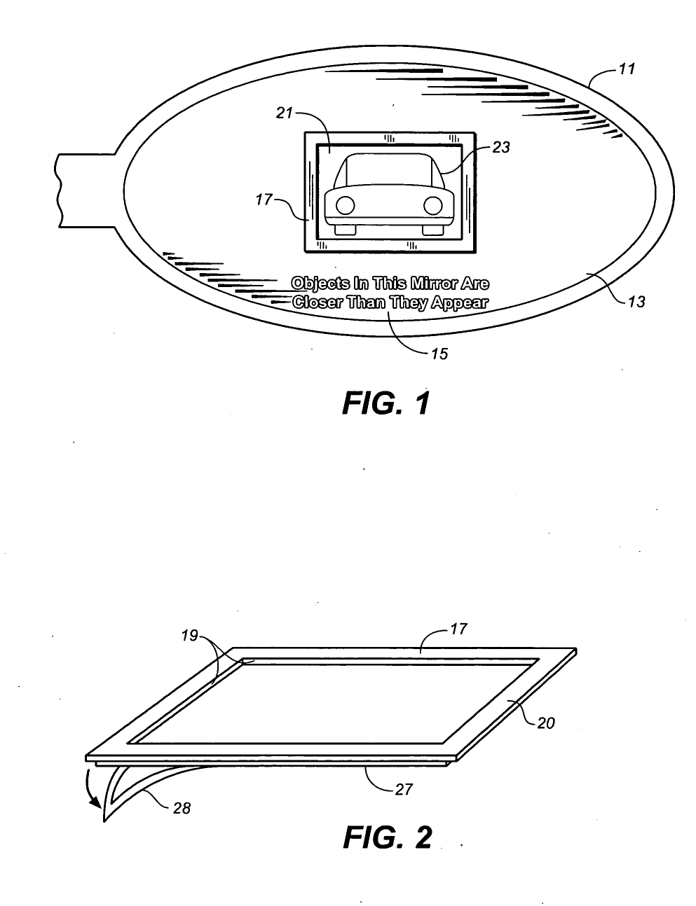

Referring to the drawings, FIG. 1 is a graphical depiction of a side view mirror such as is normally mounted on the passenger side door of a vehicle. Mirror 11 has a convex reflecting surface 13 and a mandated warning message 15 etched in the bottom region of the mirror surface, which states: “OBJECTS IN THIS MIRROR ARE CLOSER THAN THEY APPEAR.” A closed rectilinear view frame in the form of substantially square box frame 17 is applied to the mirror's reflected surface 13, preferably in the center region of the mirror just above warning message 15. The inner perimeter 19 of view frame 17 provides a bounded box-shaped target area 21 in the center of the mirror in which the image of a reflected vehicle, such as image 23, can be framed when the reflected vehicle is at a predetermined distance behind the driver's vehicle. The box-shaped target area provided by view frame 17 provides a visual reference for the reflected image of the vehicle by which to gauge the reflected vehicle's distance.

It is noted that the view frame may have a somewhat rectangular shape; however, if the long dimension greatly exceeds the short dimension of the rectangular target area, the ability to visually correlate the reflected image of a vehicle to the target area will diminish. The reference herein to “substantially square” shall be understood to allow for some rectangularity of the view frame. Preferably, for a rectangular view frame, the width of the frame will be greater than its height to better match the profile of the reflected image of a vehicle.

As hereinafter described, the size of the view frame 17 is suitably selected to frame a normal-sized vehicle at a predetermined distance behind the driver's vehicle, suitably in the range of 45 feet, a distance recommended by many law enforcement agencies as a safe distance for a lane change. The size of the view frame will depend on the convexity of the side view mirror and the distance selected for a safe lane change. For example, a 1½ inch square viewing area would be suitable for achieving a framed vehicle image at a 45 foot distance for many convex side view mirrors having a standard curvature. It is generally contemplated that view frames having dimensions of between 1½ inches to 3 inches square can be used, with a 3 inch square view frame being suitable for use on a flat side view mirror such as are typically used on the driver's side of the vehicle. It is also contemplated that the invention can be used on a convex driver's side mirror.

It is noted that in a dynamic driving situation, the driver may not see the reflected image 23 framed precisely within the view frame 17 as shown in FIG. 1, but instead may see the reflected image somewhat outside the view frame as represented by the off-set image. However, even when the image is not centered within the target area of the view frame, the driver's eyes are capable of adjusting for this off-set by comparing the size of the reflected image to the size of the target area. Again, the framed box-shaped target area produced by the view frame will provide a confident reference for the driver to gauge the vehicle's distance; one wherein the profile of the reflected vehicle image can be visually compared to a similarly shaped bounded target area. If the vehicle image exceeds the boundaries of the vehicle area, the driver will know the trailing vehicle is too close for a safe lane change; on the other hand, if the vehicle image profile corresponds in size or is smaller than the target area, a safe distance for a lane change is indicated.

Referring to FIG. 2, view frame 17 can take the form of a substantially square ring of material having an inner perimeter 19 and an outer perimeter 20, with an adhesive strip 27 on the back of the material for adhering the material to the mirror surface 13. The frame 17 can be fabricated of any suitable material, such as plastic, paper or a metal sheet material, with a peel-off backing 28 that exposes the adhesive side of the adhesive strip. The material is preferably selected or treated (such as by painting) so that the view frame is readily visible when placed on the mirror. The width of the frame, that is, that distance between the frame's inner and outer perimeters 19, 20, should also preferably be sufficient for easy visibility. It is found that a frame width of approximately ⅛ inch is an optimum width for visibility without obscuring too much of the mirror.

While it is contemplated that a stick-on frame will allow vehicle owners to easily apply the view frame to their existing vehicles and will allow different frame sizes to be selected in accordance with the mirror design and the preference for a gauged distance, it is understood that the invention is not limited to stick-on view frames, but includes a view frame applied to the mirror in any fashion, including etching the frame directly in the mirror surface, or view frames suspended in front of the mirror as described below.

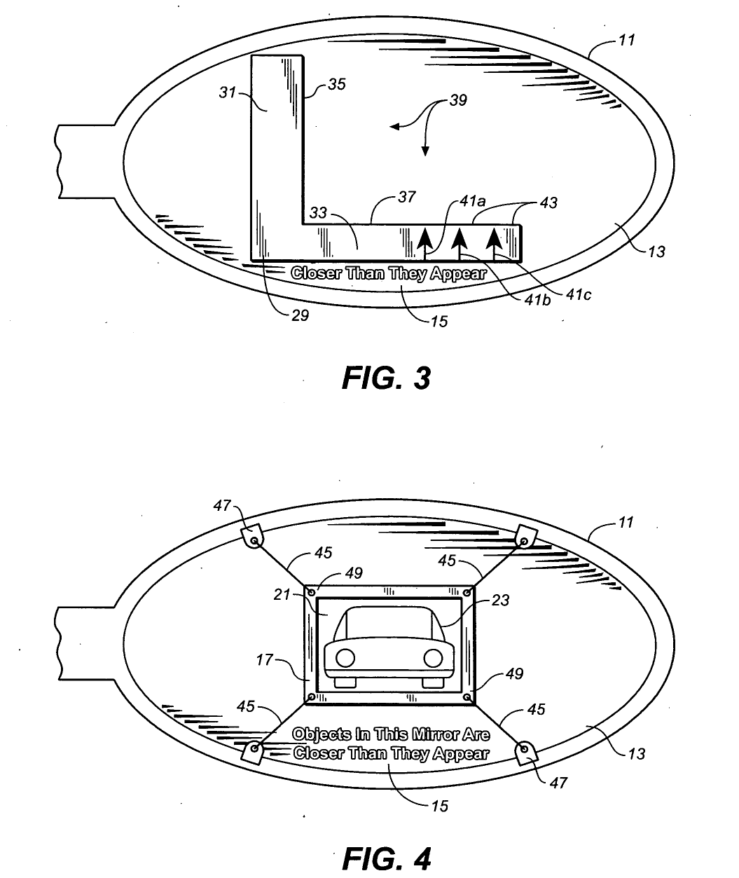

Referring to FIG. 3, a view frame sizing template 29 is shown which can be used to select the size of the view frame needed for providing a particular distance indication for a vehicle reflected in the mirror. Sizing template 29 includes a vertical leg 31 and a horizontal leg 33 having inside edges 35, 37 that define a general viewing area 39. Distance markings in the form of arrows 41a, 41b, 41c imprinted on the distal end 43 of horizontal leg 33 provide a visual reference for sizing a reflected image in the viewing area 39 of the mirror during a setup procedure. These markings can be used as hereinafter described to select an appropriately sized view frame for placement on the mirror. The distance markings shown are illustrative only. Any number or form of distance markings could be used on one or both legs of the template. Numerical indications of frame size (not shown) associated with each marking can also be imprinted on the template for convenient reference; less suitable, yet within the scope of the invention, numerical indications could serve as the distance markings themselves. Examples of numerical indications for arrows 41a, 41b, and 41c would be “1½” for one and one half inches, “2” for two inches, “2½” for two and one half inches.

To select a view frame size for a passenger side view mirror, a setup procedure is used which involves two stationary vehicles: the primary vehicle on which the view frame of the invention is to be used, and a reference vehicle. The primary vehicle is parked in a convenient, preferably off-road location, such as a parking lot, and the reference vehicle is parked at a measured distance behind and to the right of the primary vehicle to simulate the position of the reference vehicle in an adjacent lane in traffic. As mentioned, a suitable distance for the reference vehicle would be approximately 45 feet behind the primary vehicle.

Either before or after the primary and reference vehicles are positioned, the sizing template 29 is placed on the convex surface 13 of side view mirror 11 so as to place the viewing area 39 created by the template approximately in the middle of the mirror. Suitably, the template is placed on the mirror so that the horizontal leg covers the top line of warning message 15 as shown in FIG. 3. Once the template is in place, and the vehicles properly positioned, the sizing can commence as follows: seated in the driver's seat of the primary vehicle, the driver would adjust his or her passenger side view mirror to cause the reflection of the reference vehicle to be reflected in the template's viewing area 39. By aligning the reflected image of the reference vehicle to the inside edges 35, 37 of the template's vertical and horizontal legs 31, 33, the markings 41a, 41b, and 41c on the horizontal leg can be used to determine the size of the square suitable for framing the vehicle's image at the established distance for the reference vehicle. This is done by observing where on the horizontal leg the far edge of the reference vehicle's reflected image falls, and noting the distance marking on the horizontal leg. A view frame sized in accordance with the observed distance marking is then selected and adhered to the side view mirror, preferably just above warning message 15. If the image's far edge falls between markings, a frame size can be interpolated.

A similar setup procedure can be followed for selecting a view frame size for the side view mirror on the driver's side of the vehicle. In this case, the reference vehicle is placed behind and on the driver's side of the install vehicle, with the driver adjusting the driver's side mirror to place the reflected image in the viewing area 39 of sizing template 29. If the mirror on the driver's side is flat, there will be no warning message on the mirror. Apart from this possibility, the sizing of the reflected image in the template's viewing area is accomplished in the same manner as on the passenger side mirror. With a flat mirror and no distortion, the size of the needed view frame for a given reference vehicle distance would be larger than for the convex passenger side mirror.

While a right handed sizing template is illustrated, which is a template having a horizontal leg extending to the right of the vertical leg, it shall be understood that a left handed sizing template can also be used. However, for ease of viewing and noting distance markings, it is believed that a right handed template would be more suitable for the passenger side mirror, and a left handed template more suitable for a driver's side mirror.

FIG. 4 illustrates another approach to attaching the view frame 17 to side view mirror 11. (It is noted that FIG. 4 illustrates a driver's side mirror.) In this case, the view frame is suspended over the mirror's reflective surface by attaching elastic cords 45, terminated by clips 47, to the view frame's corners 49, and stretching the cords so that clips 47 can clip over an available edge of the mirror. Using this approach, the view frame would have to be sufficiently sturdy to prevent the cords from pulling the frame apart.

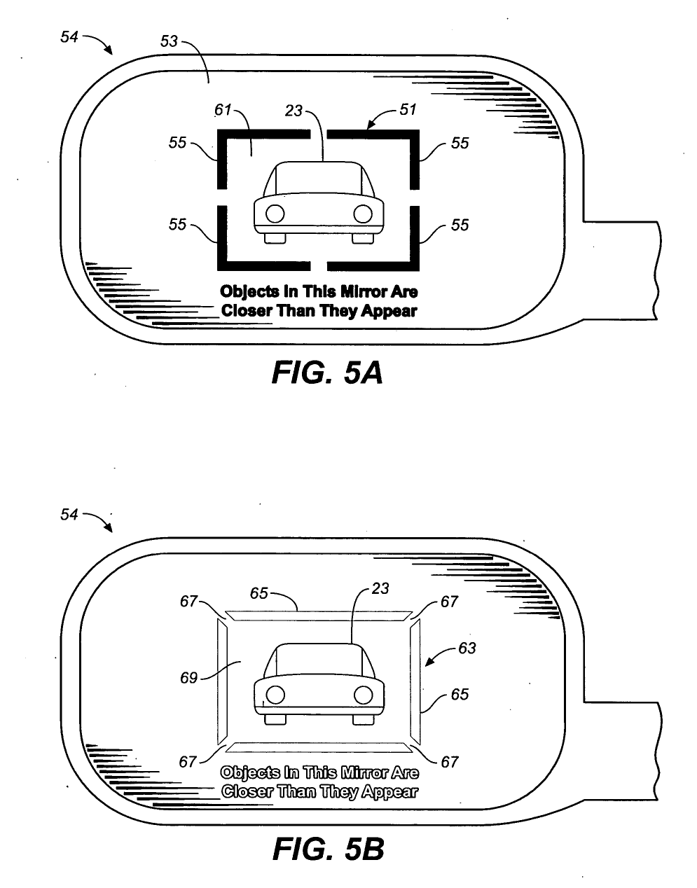

FIGS. 5A and 5B show alternative forms of the view frame of the invention, wherein the view frame is substantially, but not entirely, closed. In FIG. 5A, a rectilinear view frame 51 is produced on the reflective surface 53 of mirror 54 by rectilinear corner strips 55, which leave gaps 57 in each side of the resulting target area 61. In FIG. 5B, a rectilinear view frame 63 is provided on mirror 54 by means of four straight side strips 65 that produce corner gaps 67 at the corners of target area 69. Despite the gaps in these versions of the view frame, it is seen that in each case a well defined and bounded target area is produced that is substantially square.

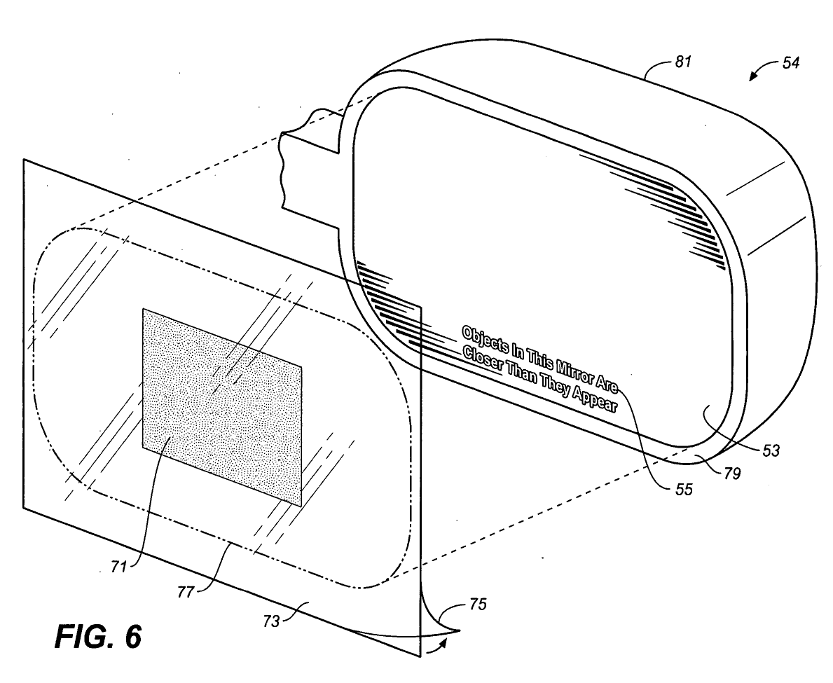

FIG. 6 illustrates another approach to producing a substantially square target area on the reflective surface of a mirror, as well as another method of applying a rectilinear view frame or target on the mirror. In FIG. 6, a substantially square target area 71 is provided on a transparent sheet 73, suitably having a peel-back backing 75, which exposes an adhesive back side of the sheet. The target area in this case is not delineated by a frame, but rather is provided by a transparent area which is colored, tinted, or otherwise made to be visually perceptible, collectively “tinted area.” To apply the target area 71 to the mirror's reflective surface, the backing 75 is simply peeled off, and the transparent plastic sheet adhered to the mirror with the target area 71 placed above the warning message 55. The excess edge material of the plastic sheet can then be cut away, as denoted by dashed lines 77, so that the plastic sheet fits within the rim 79 of the mirror frame 81. It will be appreciated that this approach to applying the target area to the mirror can also be used in connection with the above-described view frames.

Thus, it can be seen that the present invention provides for improved means of marking side view mirrors with a distance marking scheme that will provide the driver with a confident indication of when a vehicle reflected in the mirror is at a safe distance behind a driver's vehicle for making safe lane changes. While the invention has been described in some detail in the foregoing specification and the accompanying drawings, it is not intended that the scope of the invention be limited to such detail, except as necessitated by the claims below. For example, frame geometries other than those described and illustrated could be used for providing other pre-sized target area shapes, such as a circular or oval geometry. However, it is believed that the box-shaped target area provides the best geometrical compatibility with the profile of a reflected vehicle image, and would provide the best target area reference for comparison to the reflected vehicle image. Also, while the placement of the view frame is described and illustrated as being approximately at the center of the mirror above the mirror's warning message, placement of the view frame at other locations on the mirror is possible and within the scope of the invention.

What I claim is:

1. A vehicle mirror comprising
a reflective surface, and
a visually perceptible bounded target area associated with said reflective surface, said target area being reflective and providing a target shape and size which the eye can compare and correlate to the image of a trailing vehicle reflected in the mirror.

2. The vehicle mirror of claim 1 wherein said visually perceptible target area is provided by a view frame bounding said target area.

3. The vehicle mirror of claim 2 wherein said view frame is entirely closed.

4. The vehicle mirror of claim 2 wherein said view frame is substantially closed.

5. The vehicle mirror of claim 2 wherein view frame is adhered to the reflective surface of said mirror.

6. The vehicle mirror of claim 2 wherein said view frame is etched in the reflective surface of said mirror.

7. The vehicle mirror of claim 1 wherein said view frame is suspended in front of the reflective surface of said mirror.

8. The vehicle mirror of claim 1 wherein said target area is box-shaped.

9. The vehicle mirror of claim 8 wherein said target area is substantially square.

10. The vehicle mirror of claim 9 wherein said target area is between approximately one and one-half and three inches square.

11. The vehicle mirror of claim 1 wherein said target area is sized to frame the reflected image of a vehicle of normal size at a defined trailing distance behind the vehicle to which the mirror is attached.

12. The vehicle mirror of claim 1 wherein said target area is a reflective, tinted area of the mirror's reflective surface.

13. The vehicle mirror of claim 12 wherein said tinted area is produced by a colored or tinted sheet material adhered to the mirror's reflective surface.

14. The vehicle mirror of claim 12 wherein said reflective tinted area is box-shaped.

15. A vehicle mirror comprising
a reflective surface, and
a substantially closed, rectilinear view frame on said reflective surface, said view frame providing a readily visible, bounded rectilinear target area which the eye can compare and correlate to the image of a trailing vehicle reflected in the mirror, and being sized to correlate the reflected image of a trailing vehicle to a trailing distance.

16. The vehicle mirror of claim 15 wherein said view frame is substantially square.

17. The vehicle mirror of claim 16 wherein said view frame is between approximately one and one half to three inches square.

18. The vehicle mirror of claim 15 wherein said view frame is sized to frame the reflected image of a vehicle of normal size at a defined trailing distance behind the vehicle to which the mirror is attached.

19. The vehicle mirror of claim 15 wherein said view frame is adhered to the reflective surface of said mirror.

20. The vehicle mirror of claim 15 wherein said view frame is etched in the reflective surface of said mirror.

21. The vehicle mirror of claim 15 wherein said view frame is suspended in front of the reflective surface of said vehicle mirror.

22. A view frame for a vehicle mirror for gauging the distance of a trailing vehicle reflected in the reflective surface of the mirror, said view frame comprising
substantially rectilinear side portions forming a box-shaped target area on the mirror's reflective surface which the eye can compare and correlate to the image of a trailing vehicle reflected in the mirror, and
means for holding the view frame at the front of the mirror's reflective surface.

23. The view frame of claim 22 wherein said means for holding the view frame at the front of the mirror's reflective surface includes an adhesive backing on the view frame.

24. The view frame of claim 22 wherein said means for holding the view frame at the front of the mirror's reflective surface includes means for suspending the view frame in front of the reflective surface of the mirror.

25. The view frame of claim 22 wherein said view frame is substantially square.

26. The view frame of claim 25 wherein said view frame is between approximately one and one half to three inches square.

27. The view frame of claim 22 wherein said view frame is sized to frame the reflected image of a vehicle of normal size at a defined trailing distance behind the vehicle to which the mirror is attached.

28. A method of providing a visually perceptible target area on a reflective surface of a vehicle side mirror which the eye can compare and correlate to the image of a trailing vehicle reflected in the mirror in order to assess the distance of the reflected vehicle, comprising
determining the size of a box-shaped target area that correlates to the size of a reflected image of a trailing vehicle which is at a desired safe trailing distance,
providing a box-shaped target area on the reflective surface of the mirror sized in accordance with such determination, such that a vehicle image reflected in the side mirror can be correlated to the target area to visually indicate when a trailing vehicle reflected in the side mirror is trailing by a sufficient distance for safe a lane change.

29. The method of claim 28 wherein determining the desired size of the box shaped target area is comprised of the steps of
placing a sizing template on the reflective surface of a vehicle side mirror of a primary vehicle, said sizing template having image size indications,
providing for a stationary reference vehicle behind said primary vehicle at a desired distance representing a safe lane change distance, such that the reference vehicle will be reflected in the side mirror of the primary vehicle,
lining up the reflected image of the reference vehicle in the primary vehicle side mirror with the sizing template,
noting the size of the reflected image of the reference vehicle on the reflective surface of the vehicle side mirror, and
providing a target area on the reflective surface of the vehicle mirror sized in accordance with the noted size of the reflected image of the reference vehicle.

30. The method of claim 29 wherein said sizing template includes a vertical leg and a horizontal leg having inside edges that define a general viewing area, and wherein image size indications are provided on at least one of said vertical and horizontal legs.

31. The method of claim 30 wherein said image size indications are provided on the horizontal leg of the sizing template.

32. The method of claim 29 wherein said sizing template has an L-shape, and the image size indications are provided on the horizontal leg of said L-shaped template.
